(19) United States
(12) Patent Application Publication
(10) Pub. No.: US 2018/0056563 A1
(43) Pub. Date: Mar. 1, 2018

(54) APPARATUS FOR MOLDING PLASTIC ELEMENTS

(71) Applicant: SACMI IMOLA S.C., Imola (IT)

(72) Inventors: Daniele MARASTONI, San Giovanni In Persiceto (IT); Rossano MOSCA, Caerano Di San Marco (IT)

(21) Appl. No.: 15/557,566

(22) PCT Filed: Mar. 10, 2016
(86) PCT No.: PCT/EP2016/055101

§ 371 Date: Sep. 12, 2017

(30) Foreign Application Priority Data
Mar. 12, 2015 (IT) VR2015A000042

(51) Int. Cl. B29C 45/40

(52) U.S. Cl. CPC B29C 45/4005; B29C 33/442

(57) ABSTRACT

An apparatus for molding plastic elements includes a device for injection molding elements made of plastics and a device for unloading the molded plastic elements from the molding device. The molding device is associated with an extraction plate adapted to move, on command, at least one part of the molding device in order to allow the unloading of the plastic elements. The extraction plate is connected functionally, by way of posts to an actuation element and an abutment body and further actuation elements are provided which act between the abutment body and the actuation element and are adapted to move, substantially parallel to the direction of extension of the posts, the actuation element with respect to the abutment body. The abutment body is arranged between the extraction plate and the actuation element.

### TECHNICAL FIELD

The present disclosure relates to an apparatus for molding plastic elements such as, for example, preforms for the production of plastic containers or caps.

### BACKGROUND

Typically, such apparatuses comprise a device for injection molding a plurality of elements made of plastics and a device for unloading the molded plastic elements from the molding device.

The molding device is associated with an extraction plate, which is adapted to move, on command, at least one part of the molding device in order to allow the unloading of the molded plastic elements.

The extraction plate is connected functionally, by way of a plurality of pusher and traction posts, to an actuation element.

The apparatus is further provided with an abutment body and actuation means, which act between the abutment body and the actuation element.

In particular, the actuation means are adapted to move, substantially parallel to the direction of extension of the pusher and traction posts, the actuation element with respect to the abutment body so as to actuate, by way of the pusher and traction posts, the extraction plate.

In the known solutions, the abutment body is positioned, with respect to the actuation element, on the opposite side with respect to the extraction plate.

The solution described above, although widely used, is not devoid of drawbacks, however.

In particular a certain difficulty has been encountered in accessing, for checking and maintenance operations, the actuation element, especially if it is necessary, owing to a change of format, to work on the pusher and traction posts.

Furthermore, between the actuation element and the abutment body guiding means must be provided, which are typically constituted by a plurality of linear guides intended to ensure the precision of movement and the support of the actuation element during its movement.

### SUMMARY

The aim of the present disclosure is to eliminate, or at least to drastically reduce, the above mentioned drawbacks.

Within this aim, the disclosure provides an apparatus that makes it possible to access the actuation element and the pusher and traction posts in an extremely practical manner.

The disclosure further provides an apparatus that makes it possible to reduce, and in some applications to eliminate, the linear guides arranged between the actuation element and the abutment body, with a consequent simplification in terms of design and construction.

These advantages which will become better apparent hereinafter are achieved by an apparatus for molding plastic elements according to claim 1.

### BRIEF DESCRIPTION OF THE DRAWINGS

Further characteristics and advantages of the disclosure will become better apparent from the description of some preferred, but not exclusive, embodiments of an apparatus for molding plastic elements according to the disclosure, which are illustrated by way of non-limiting example in the accompanying drawings wherein:

FIG. 1 is a perspective view of the abutment body;

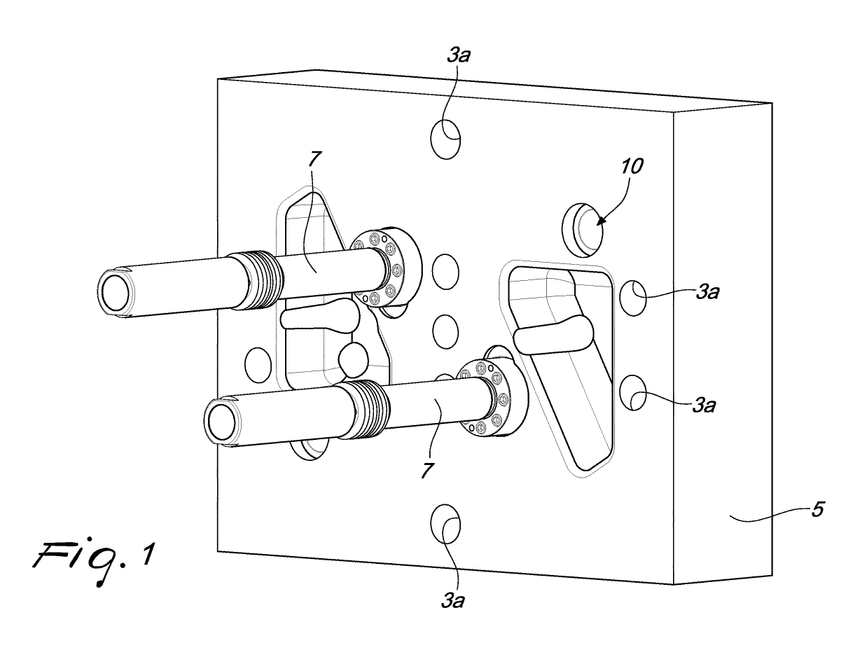

FIG. 2 is a front elevation view of the apparatus;

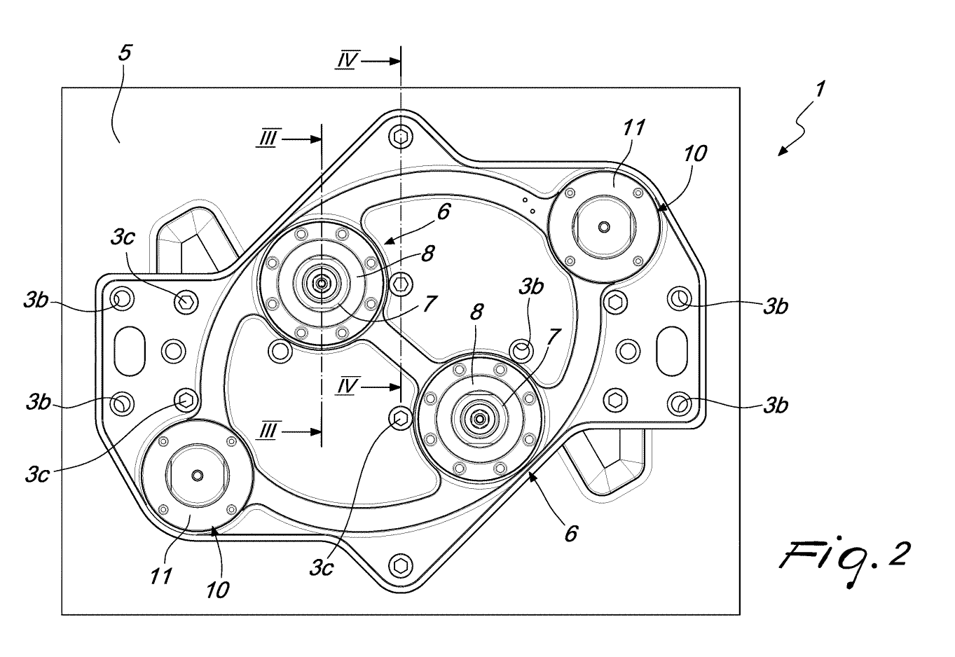

FIG. 3 is a cross-sectional view of the apparatus, taken along the line III-III in FIG. 2;

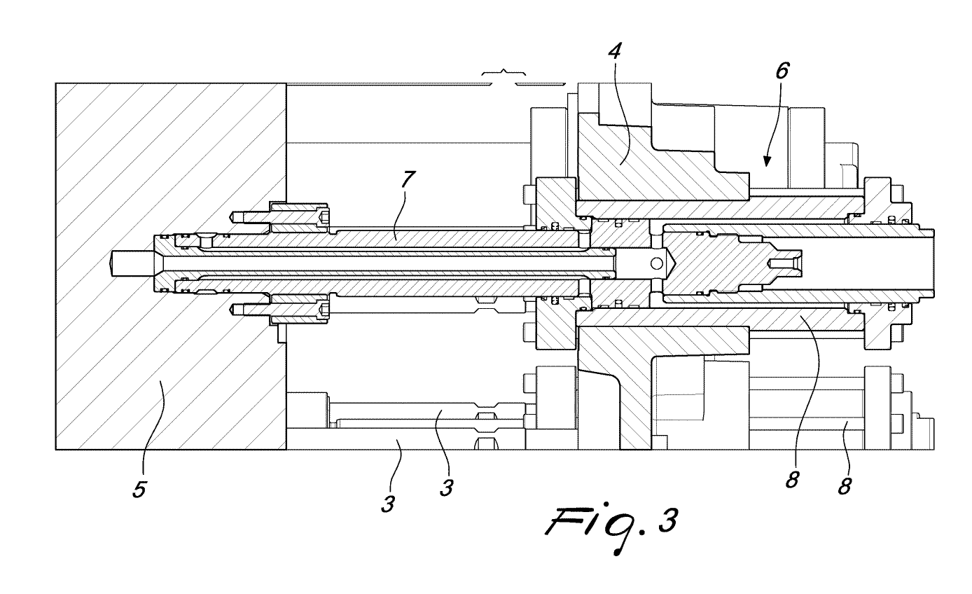

FIG. 4 is a cross-sectional view, taken along a plane of arrangement designated by the line IV-IV in FIG. 2, of a portion of the apparatus in which the actuation element is spaced apart from the abutment body;

FIG. 5 is a cross-sectional view similar to the previous view and wherein the actuation element is brought close to the abutment body; and

FIG. 6 is a perspective view of the actuation element associated with the pusher and traction posts.

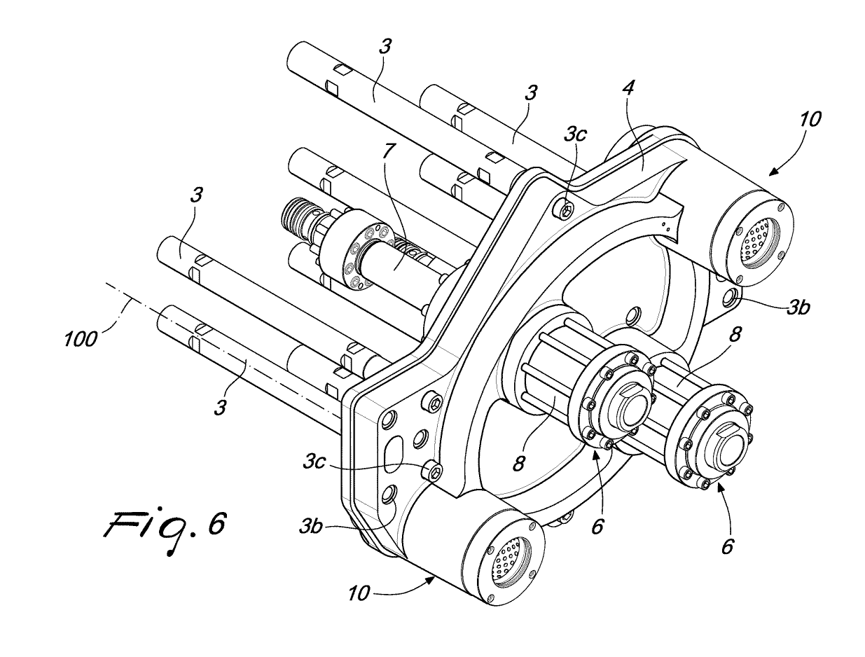

### DETAILED DESCRIPTION OF THE DRAWINGS

With reference to the figures, the present disclosure relates to an apparatus, generally designated by the reference numeral 1, for molding plastic elements.

The apparatus 1 comprises a device, not shown in the figures, for injection molding a plurality of elements made of plastics and a device for unloading the molded plastic elements from the molding device.

The molding device is associated with an extraction plate 2.

The extraction plate 2 is adapted to move, on command, at least one part of the molding device in order to allow the unloading of the plurality of elements made of plastics.

The extraction plate 2 is connected functionally, by way of a plurality of posts 3, to an actuation element 4.

Conveniently, the posts 3 extend along a direction of extension, designated with the reference numeral 100.

The posts 3 are, typically, the pusher and traction posts.

The apparatus 1 further comprises an abutment body 5 and actuation means 6 which act between the abutment body 5 and the actuation element 4.

The actuation means 6 are adapted to move, substantially parallel to the direction of extension 100 of the pusher and traction posts 3, the actuation element 4 with respect to the abutment body 5.

According to the present disclosure, the abutment body 5 is arranged between the extraction plate 2 and the actuation element 4.

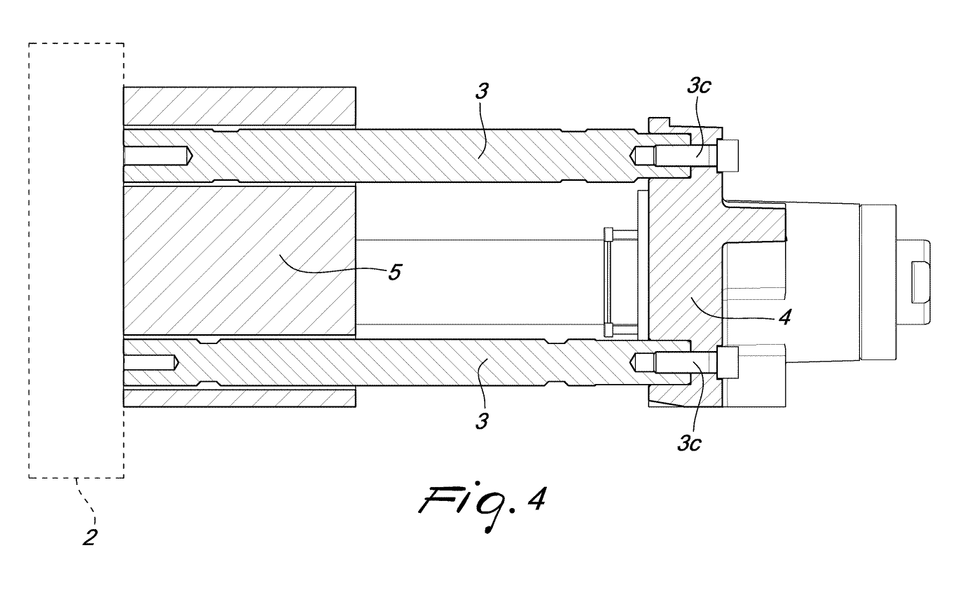

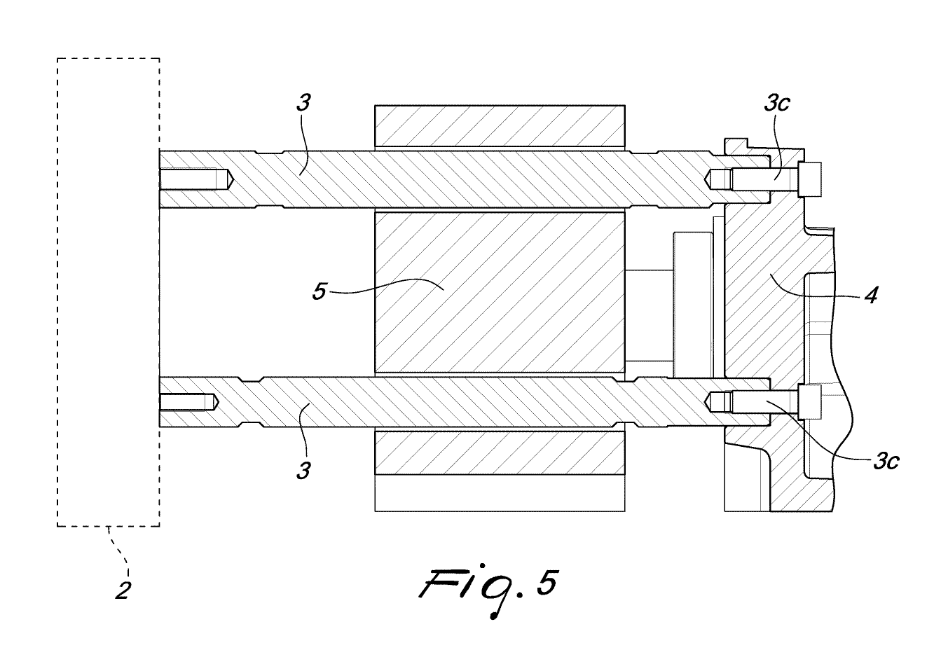

The movement of the actuation element 4 with respect to the abutment body 5 produces the transition of the extraction plate 2 from a retracted position (shown in FIG. 5) and an extended position (shown in FIG. 4) and vice versa.

In particular, with reference to the direction of extension 100 of the pusher and traction posts 3, the abutment body is arranged between the extraction plate 2 and the actuation element 4.

According to a preferred embodiment, the actuation means 6 comprise at least one linear actuator.

Such linear actuator comprises a stem 7 and a respective cylinder 8.

Conveniently, the stem 7 is supported integrally by the abutment body 5 and the respective cylinder 8 is supported integrally by the actuation element 4.

Advantageously, the (or each) linear actuator extends substantially parallel to the direction of extension 100 of the pusher and traction posts 3.

According to a particularly important aspect of the present disclosure, the (or each) linear actuator provides guiding means for moving the actuation element 4 with respect to the supporting body 5.

Advantageously, the extension in a longitudinal direction of the or of each cylinder 8 is at least equal to 120% of the stroke of the stem 7 with respect to the cylinder 8 and, preferably, at least equal to 140% of the stroke of the stem 7 with respect to the cylinder 8.

Having the cylinders integral with the actuation element 4 and the stems 7 integral with the abutment body 5 makes it possible to keep the support (through the cylinders 8) of the actuation element 4 constant during all of the back and forth motion of the cylinders 8 along the respective stems 7, making it possible to obtain a solution that enables the movement means 6 to perform the function of guiding means, thus reducing, and in some cases making it possible to eliminate, some or all of the movement guides with considerable advantages in terms of design and construction and increasing the ease of accessing the various components of the apparatus 1.

The extension, longitudinally, of the stems 8 with respect to the stroke also increases the guiding and supporting function of the movement means 6.

One or more guides 10, 11 can still be arranged between the actuation element 4 and the abutment body 5 for supporting and bearing the actuation element 3.

Conveniently, the actuation means 6 comprise at least two linear actuators, each one of which comprises a stem 7 and a respective cylinder 8.

In particular, the stems 7 are supported integrally by the abutment body 5 and the respective cylinders 8 are supported integrally by the actuation element 4.

Conveniently, the (or each) linear actuator is powered by a hydraulic circuit.

According to a preferred embodiment, the actuation element 4 comprises a plate-like body that lies on a plane that is substantially parallel to the plane of arrangement of the extraction plate 2.

The actuation element 4 defines a plurality of locking seats 3b with respect to which respective pusher and traction posts 3 can be selectively and removably locked and released by way of locking means 3c.

The locking means 3c can be associated with and disassociated from the actuation element 4 in order to lock and release the respective pusher and traction posts 3 by intervening on the surface 4a of the actuation element 4 which is on the opposite side with respect to the extraction plate 2.

The abutment body 5 has a plurality of through openings 3a which are arranged substantially facing toward the locking seats 3b and can be passed through by the pusher and traction posts 3 associated with the actuation element 4 during the operations to move the extraction plate 2 from the retracted position to the extended position and vice versa.

The special structure of the apparatus 1 and the positioning of the abutment body 5 on the same side of the extraction plate 2 as the actuation element 4 makes it possible to access the surface 4a extremely easily.

Preferably, the plastic elements comprise preforms for the production of plastic containers.

The plastic elements can also be constituted by caps.

Operation of an apparatus 1 according to the disclosure is evident from the foregoing description.

The apparatus 1, thanks to the action of the actuation means 6, actuates the movement of the extraction plate 2 which is moved between the retracted position and the extended position and vice versa.

Arranging the abutment body between the extraction plate 2 and the actuation element 4 allows an extremely practical and effective access to the actuation element 4 proper, thus facilitating operations on the pusher and traction posts 3.

Furthermore, having the actuation means 6 constituted by stems 7 and cylinders 8 that extend for a considerable length with respect to the stroke of the cylinders 8 makes it possible to ensure that such actuation means also perform the function of guiding means and supporting means for the actuation element 4, thus making it possible to limit, and in some cases eliminate, the use of the linear guides 10.

The disclosure, thus conceived, is susceptible of numerous modifications and variations.

In practice the materials employed, provided they are compatible with the specific use, and the dimensions and shapes, may be any according to requirements.

Moreover, all the details may be substituted by other, technically equivalent elements.

The disclosures in Italian Patent Application No. VR2015A000042 (102015902337902) from which this application claims priority are incorporated herein by reference.

1-12. (canceled)

13. An apparatus for molding plastic elements comprises a device for injection molding a plurality of elements made of plastics and a device for unloading said molded plastic elements from said molding device, said molding device being associated with an extraction plate adapted to move, on command, at least one part of said molding device in order to allow the unloading of said plurality of plastic elements, said extraction plate being connected functionally, by way of a plurality of posts, to an actuation element, there being an abutment body and actuation means which act between said abutment body and said actuation element and are adapted to move, substantially parallel to the direction of extension of said posts, said actuation element with respect to said abutment body, wherein said abutment body is arranged between said extraction plate and said actuation element.

14. The apparatus according to claim 13, wherein said actuation means comprise at least one linear actuator, which comprises a stem and a respective cylinder, said stem being supported integrally by said abutment body and the respective cylinder being supported integrally by said actuation element.

15. The apparatus according to claim 13, wherein said posts comprise pusher and/or traction posts.

16. The apparatus according to claim 14, wherein said at least one linear actuator extends substantially parallel to the direction of extension of said pusher and traction posts.

17. The apparatus according to claim 14, wherein said at least one linear actuator provides guiding means for moving said actuation element with respect to said supporting body.

18. The apparatus according to claim 14, wherein an extension in a longitudinal direction of said cylinders is at least equal to 120% of a stroke of the respective stem, so as to provide said guiding means.

19. The apparatus according to claim 13, wherein said actuation means comprise at least two linear actuators, each one of which comprises a stem and a respective cylinder, said stems being supported integrally by said abutment body and the respective cylinders being supported integrally by said actuation element.

20. The apparatus according to claim 14, wherein said at least one linear actuator is powered by a hydraulic circuit.

21. The apparatus according to claim 13, wherein said actuation element comprises a plate-like body that lies on a plane that is substantially parallel to a plane of arrangement of said extraction plate.

22. The apparatus according to claim 13, wherein said actuation element defines a plurality of locking seats with respect to which respective pusher and traction posts can be selectively and removably locked and released by way of locking means.

23. The apparatus according to claim 22, wherein said locking means can be associated with and disassociated from said actuation element in order to lock and release the respective pusher and traction posts with respect to the surface of said actuation element, said surface being on the opposite side with respect to said extraction plate.

24. The apparatus according to claim 13, wherein said plastic elements comprise preforms for the production of plastic containers.
